(19) United States
(12) Patent Application Publication
(10) Pub. No.: US 2013/0024236 A1
(43) Pub. Date: Jan. 24, 2013

(54) METHODS FOR PRODUCT MANAGEMENT AND DEVICES THEREOF

(71) Applicant: Jonathan Billy Byatt, London (GB)

(72) Inventor: Jonathan Billy Byatt, London (GB)

(73) Assignee: INFOSYS LIMITED, Bangalore (IN)

(21) Appl. No.: 13/542,757

(22) Filed: Jul. 6, 2012

(30) Foreign Application Priority Data
Jul. 19, 2011 (IN) 2447/CHE/2011

(51) Int. Cl. G06Q 10/06

(52) U.S. Cl. 705/7.23; 705/7.25

(57) ABSTRACT

Methods, devices, and computer-readable storage media for managing a product include receiving event data related to one or more events associated with a lifecycle of a portfolio of one or more products. The received event data is compared with a resource model. An estimated number of resources required to implement the one or more events is determined based at least in part on the comparing. Based at least in part on the received data, a dashboard including one or more analytic modules is displayed. At least one of the analytic modules includes a roadmap across the portfolio of one or more products. The roadmap includes a timeline of the one or more events and the determined estimated number of resources required to implement each of the one or more events.

This application claims the benefit of Indian Patent Application Filing No. 2447/CHE/2011, filed Jul. 19, 2011, which is hereby incorporated by reference in its entirety.

### FIELD

This technology generally relates to methods for managing a product and, more particularly, relates to methods for displaying a roadmap including a timeline of one or more events associated with a lifecycle of a portfolio of one or more products and an estimated number of resources required to implement each of the one or more events and devices thereof.

### BACKGROUND

Product management tools are commonly utilized to manage requirements of a new product from conception to launch. However, such tools do not deal with management of a mature product through end of life (EOL) and end of sales and support (EOSS). Furthermore, such tools do not allow for an accurate determination of the number of resources or costs required to implement events occurring throughout the entire lifecycle of a product. The lack of an integrated product management tool which can provide such requisite resource and cost determinations can result in overlapping or duplication of activities, delayed product launches, inaccurate pricing, inconsistent documentation, and/or inconsistent levels of service.

### SUMMARY

An exemplary method for managing a product includes receiving, by a product management computing device, event data related to one or more events associated with a lifecycle of a portfolio of one or more products. The received event data is compared with a resource model by the product management computing device. An estimated number of resources required to implement the one or more events is determined by the product management computing device based at least in part on the comparing. Based at least in part on the received data, a dashboard including one or more analytic modules is displayed by the product management computing device. At least one of the analytic modules includes a roadmap across the portfolio of one or more products. The roadmap includes a timeline of the one or more events and the determined estimated number of resources required to implement each of the one or more events.

An exemplary computer-readable storage medium having stored thereon instructions for managing a product. The instructions include machine executable code which, when executed by at least one processor, causes the processor to perform steps including receiving event data related to one or more events associated with a lifecycle of a portfolio of one or more products. The received event data is compared with a resource model. An estimated number of resources required to implement the one or more events is determined based at least in part on the comparing. Based at least in part on the received data, a dashboard including one or more analytic modules is displayed. At least one of the analytic modules includes a roadmap across the portfolio of one or more products. The roadmap includes a timeline of the one or more events and the determined estimated number of resources required to implement each of the one or more events.

An exemplary product management computing device including one or more processors and a memory coupled to the one or more processors which are configured to execute programmed instructions stored in the memory, the programmed instructions including receiving event data related to one or more events associated with a lifecycle of a portfolio of one or more products. The received event data is compared with a resource model. An estimated number of resources required to implement the one or more events is determined based at least in part on the comparing. Based at least in part on the received data, a dashboard including one or more analytic modules is displayed. At least one of the analytic modules includes a roadmap across the portfolio of one or more products. The roadmap includes a timeline of the one or more events and the determined estimated number of resources required to implement each of the one or more events.

This technology provides more effective and efficient methods and devices for product lifecycle management. Additionally, this technology provides an integrated methodology by which events associated with a lifecycle of a portfolio of products can be easily evaluated with respect to the resources and costs necessary to implement them. Beneficially, project managers can actively track product roadmaps and associated costs and make quick, informed decisions regarding product upgrades, product replacements, and the like.

### BRIEF DESCRIPTION OF THE DRAWINGS

FIG. 1 is a block diagram of an environment with an exemplary product management computing device;

FIG. 2 is a flowchart of an exemplary method for managing a product;

FIG. 3 is an exemplary product management dashboard;

FIG. 4A is an exemplary roadmap module view;

FIG. 4B is an exemplary roadmap module and resource estimator;

FIG. 5 is an exemplary pricing module;

FIG. 6 is an exemplary installed base module; and

FIG. 7 is an exemplary activities tracker module.

### DETAILED DESCRIPTION

This technology is directed to methods, systems, and computer-readable storage media for managing a product. Such product management techniques may include, for example, displaying a roadmap including a timeline of one or more events associated with a lifecycle of a portfolio of one or more products and an estimated number of resources required to implement each of the one or more events.

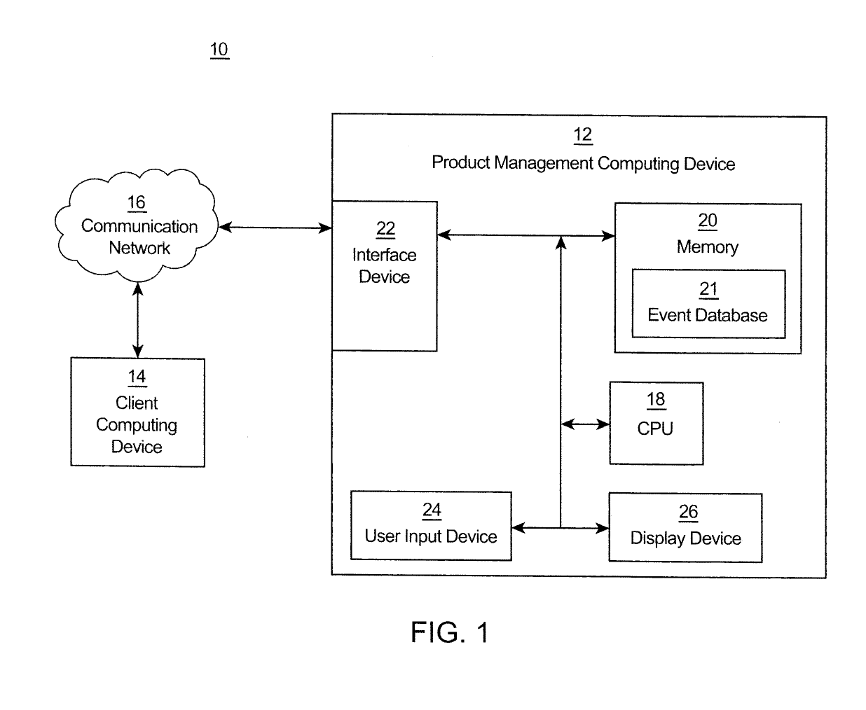

Referring more specifically to FIG. 1, an environment 10 with an exemplary product management computing device 12 is illustrated. The environment 10 includes the product management computing device 12 and one or more client computing devices 14 which are all coupled together by one or more communication networks 16, although this environment can include other numbers and types of systems, devices, components, and elements in other configurations. This technology provides a number of advantages including providing more effective and efficient methods and devices for product lifecycle management. Additionally, this technology provides an integrated methodology by which events associated with a lifecycle of a portfolio of products can be easily evaluated with respect to the resources and costs necessary to implement them.

In this example, the product management computing device 12 receives event data related to one or more events associated with a lifecycle of a portfolio of one or more products. The product management computing device 12 compares the received event data with a resource model. Based at least in part on the comparing, the product management computing device 12 determines an estimated number of resources required to implement each of the one or more events. Based at least in part on the received data, the product management computing device 12 displays a dashboard including one or more analytic modules. At least one of the analytic modules includes a roadmap across the portfolio of one or more products. The roadmap includes a timeline of the one or more events and the determined estimated number of resources required to implement each of the one or more events. The product management computing device may, however, perform other numbers and types of functions. The product management computing device 12 includes a central processing unit (CPU) or processor 18, a memory 20 with an event database 21, an interface device 22, a user input device 24, and a display device 26 which are coupled together by a bus or other link, although other numbers and types of systems, devices, components, and elements in other configurations and locations can be used. The processor 18 in the product management computing device 12 executes a program of stored instructions for one or more aspects of the present technology as described and illustrated by way of the examples herein, although other types and numbers of processing devices and logic could be used and the processor could execute other numbers and types of programmed instructions.

The memory 20 in the product management computing device 12 stores these programmed instructions for one or more aspects of the present technology as described and illustrated herein, although some or all of the programmed instructions could be stored and executed elsewhere. In this example, the memory 20 includes the event database 21 which may be an MS SQLServer database, although other types and numbers of databases which are stored at other locations could be used. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18 in the product management computing device 12, can be used for the memory 20 in the product management computing device 12.

The interface device 22 in the product management computing device 12 may be used to operatively couple and communicate between the product management computing device 12 and the one or more client computing devices 14 via one or more of the communications networks 16, although other types and numbers of communication networks or systems with other types and numbers of connections and configurations can be used. By way of example only, the one or more communications networks can use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The user input device 24 in the product management computing device 12 includes a computer keyboard and a computer mouse, although other types and numbers of user input devices can be used. In this example, the user input device 24 in the product management computing device 12 may be used to input event data related to events associated with a lifecycle of a portfolio of products, although other types of data and information could be entered in other manners.

The display device 26 in the product management computing device 12 includes a computer display screen, such as a CRT or LCD screen, although other types and numbers of displays could be used. In this example, the display device 26 in the product management computing device 12 may be used to display a dashboard including analytic modules such as a roadmap of events across a portfolio of products along with an estimated number of resources required to implement each of the events, although other types of data and information and other types of graphical user interfaces could be displayed.

Each of the one or more client computing devices 14 includes a central processing unit (CPU) or processor, a memory, an interface device, a user input device, and a display which are coupled together by a bus or other link, although each could comprise other numbers and types of devices, elements, and components in other configurations. Each of the one or more client computing devices 14 may be remotely located from the product management computing device 12, although other configurations could be used. The processor in the each of the one or more client computing devices 14 can execute a non-transitory program of stored instructions for one or more aspects of the present technology as described and illustrated by way of the examples herein, although other types and numbers of processing devices and logic could be used and the processor could execute other numbers and types of programmed instructions. The display of each of the one or more client computing devices 14 may be used to display a user based interface (e.g., Excel) with one or more form fields. The user input device of each of the one or more client computing devices 14 may be used to input the event data in the form fields of the user based interfaces which are configured to directly provide the event data to the product management computing device 12 for managing a portfolio of one or more products, although other types and numbers of functions could be performed. Although one client computing device 14 is shown, other numbers of client computing devices and other types and numbers of systems and devices which can display and provide interaction with the user based interface can be used.

Although examples of the product management computing device 12 and the one or more client computing devices 14 are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

The present disclosure involves providing more effective and efficient methods and devices for product lifecycle management using a user interface dashboard. This technology provides an integrated methodology by which events associated with a lifecycle of a portfolio of products can be easily evaluated with respect to the resources and costs necessary to implement them in a display environment. Beneficially, project managers can actively track product roadmaps and associated costs and make quick, informed decisions regarding product upgrades, product replacements, and the like.

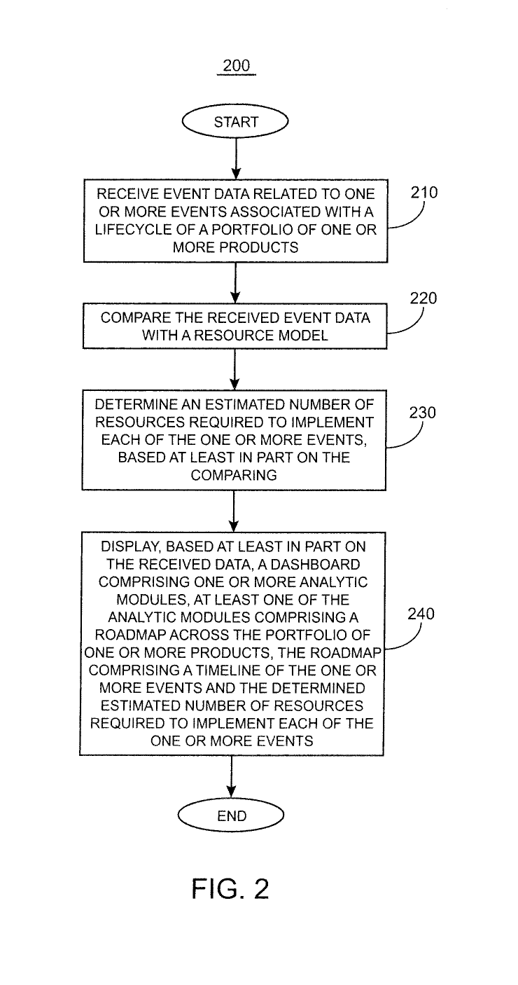

FIG. 2 is a flowchart of an exemplary method 200 for managing a product. With reference to FIG. 1, the method 200 includes a product management computing device 12 receiving event data related to one or more events associated with a lifecycle of a portfolio of one or more products (block 210). At least a portion of the event data may be received from one or more divisions of an organization or company charged with managing various aspects of the product and/or the one or more events. Additionally or alternatively, a portion of the event data may be received from external sources such as suppliers and/or retailers associated with the managing organization or the event, or from any other suitable source. Exemplary products may include telecommunication products, software, storage systems, computing devices, or any other suitable products. Event data may include, for example, scheduled or anticipated events associated with the lifecycle of the portfolio of products as well as a timing of, a pricing associated with, and/or sales and marketing information relevant to each event. Such events may include such event types as minor or major upgrades, security updates, patches, new releases, end of sale, end of support, or any other suitable type of event. Product management computing device 12 may store the received event data in event database 21 for immediate or future use.

The product management computing device 12 compares the received event data with a resource model (block 220). The resource model may include a mapping of an event type to an estimated number of resources required to implement an event of that type. The mapping may be based on a complexity of the event type. In some embodiments, the estimated number of resources may include a projected amount of labor required from one or more divisions of an organization or company charged with managing various aspects of the product and/or the event type. The resource estimate may be expressed in man days, man hours, overtime hours, or in any other suitable resource unit. Alternatively or additionally, the estimated number of resources may include projected types and numbers of required equipment, along with such associated resources as gas, electricity, and the like. Accordingly, the resource estimate may be alternatively or additionally expressed in gallons, kilowatt-hours (kWh), or in any other suitable resource unit. The resource model and its resource estimates may be customized based on characteristics of the managing organization, such as its expertise, personnel, equipment inventory, and so on.

In some embodiments, the comparing of the received event data with the resource model may include compiling at least a portion of the event data into an event template associated with the resource model. The product management computing device 12 then determines an estimated number of resources required to implement each of the one or more events, based at least in part on the comparing (block 230). In some embodiments, the resource model may be associated with a cost model, thereby allowing the product management computing device 12 to further determine an estimated cost required to implement each of the events. In some of these embodiments, product management computing device 12 may map each resource model input to a monetary cost per unit of time. Based on this mapping, product management computing device 12 may compute an estimated cost for each resource model input based on multiplying the cost per unit of time by the estimated time required from the resource model input. Summing this estimated cost across all resource model inputs required for the particular event being evaluated yields an overall estimated cost required to implement the particular event. The cost model may be customized by the managing organization based on its budgetary constraints and/or forecasts.

In some embodiments, the product management computing device 12 may uniquely map each received event to a code denoting the event type. Each event type may in turn be associated to a rating denoting the complexity of the event. The complexity rating may likewise be mapped to an event template having a corresponding predetermined resource model detailed within. For example, as depicted in Table 1, a major upgrade may be assigned a code “MU”. This MU code may have a complexity rating 3. A level 3 complexity rating may in turn have a predetermined resource model of 15 man days: 3 man days of Product Management; 1 man day Security Validation; 5 man days Product Engineering; 4 man days Operational Validation, Adoption, and Release; and 2 man days Project Management. The cost model depicted in Table 2 indicates that each Product Management resource input corresponds to a cost of 1200 monetary units per man day; each Security Validation resource input corresponds to 500 monetary units per man day; each Product Engineering resource input corresponds to a cost of 250 monetary units per man day; each Operational Validation, Adoption, and Release resource input corresponds to a cost of 250 monetary units per man day; and each Project Management resource input corresponds to a cost of 500 monetary units per man day. Based on this cost model, project management computing device 12 may determine that the major upgrade may correspond to an estimated cost of (3×1200)+(1×500)+(5×250)+(4×250)+(2×500)=7350 monetary units.

TABLE 1
Exemplary Event Templates

| | | | Resource | |
|---|---|---|---|---|
| | | Complexity | Model | |
| Event Type | Code | Rating | (man days) | Cost |
| Minor Upgrade | MN | 2 | SM(1). SE(0.5), | 2,075 |
| | | | PE(2), OP(0.5), | (4 man days) |
| Security | SEC | 1 | SM(0.5), PE(1) | 1,225 |
| Update | | | SE(0.5), OP(0.5) | (2.5 man days) |
| Patch/Bug Fix | PBF | 1 | SM(0.5), PE(1), | 1,225 |
| | | | SE(0.5), OP(0.5) | (2.5 man days) |
| Major Upgrade | MU | 3 | SM(3). SE(1), | 7,350 |
| | | | PE(5), OP(4), | (15 man days) |
| | | | PM(2) | |
| New Release | NR | 3 | SM(5). SE(2), | 16,900 |
| | | | PE(8), OP(4), | (33 man days) |
| | | | PM(4), IT(6), | |
| | | | LG(2), GS(2) | |

TABLE 2
Exemplary Resource Inputs and Cost Model
Associated with Event Templates

| | | Cost (per |
|---|---|---|
| Resource | Code | man day) |
| Product Manager | SM | 1200 |
| Product Engineer | PE | 250 |
| Security Engineer | SE | 500 |
| Operational Analyst | OP | 250 |
| Project Manager | PM | 500 |
| Legal | LG | 750 |
| IT Development | IT | 400 |
| Global | GS | 500 |
| Sourcing/Procurement | | |

In some embodiments, the resource model and associated event templates and cost models may be predetermined, based on, e.g., the budgetary constraints and employment structure of the particular user of exemplary method 200. Alternatively or additionally, a user may modify any portion of the resource model, the event templates, or the cost models via user input device 24.

In block 240, the product management computing device 12 displays, e.g., on display device 26, a dashboard including one or more analytic modules, based at least in part on the received data. At least one of the analytic modules includes a roadmap across the portfolio of one or more products. The roadmap includes a timeline of the one or more events and the determined estimated number of resources required to implement each of the one or more events.

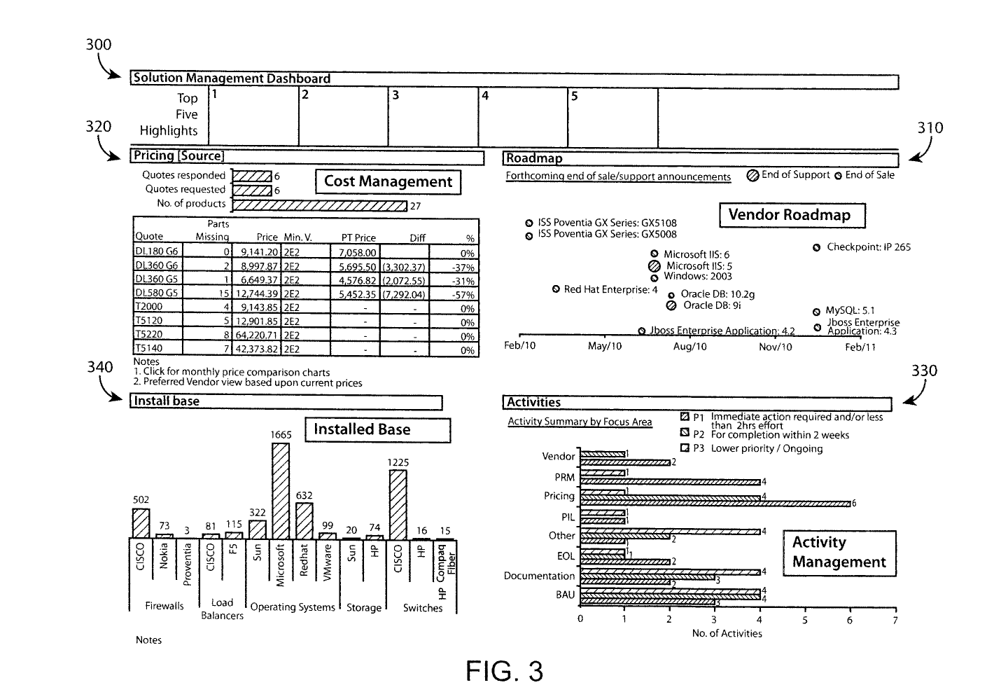

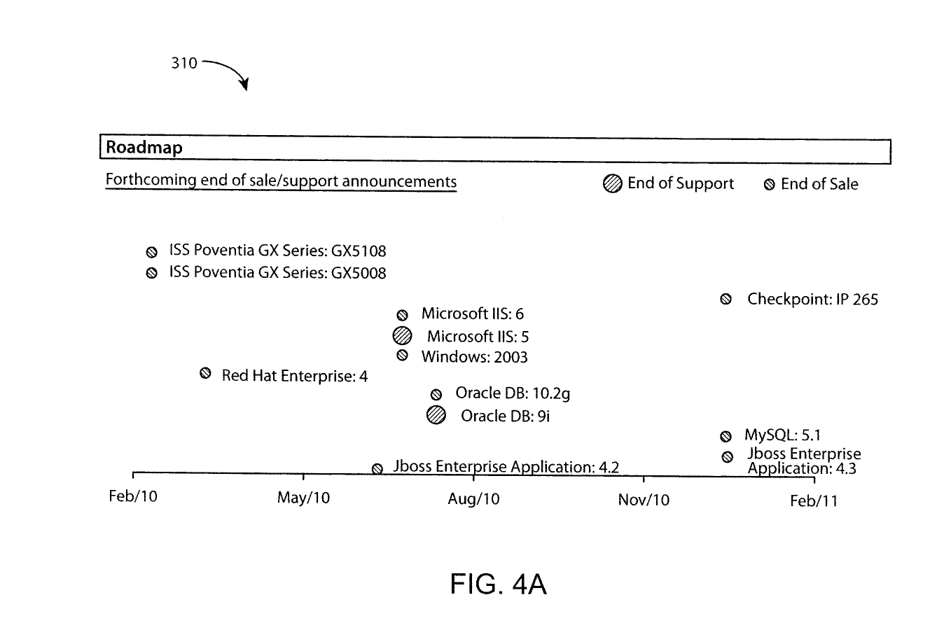

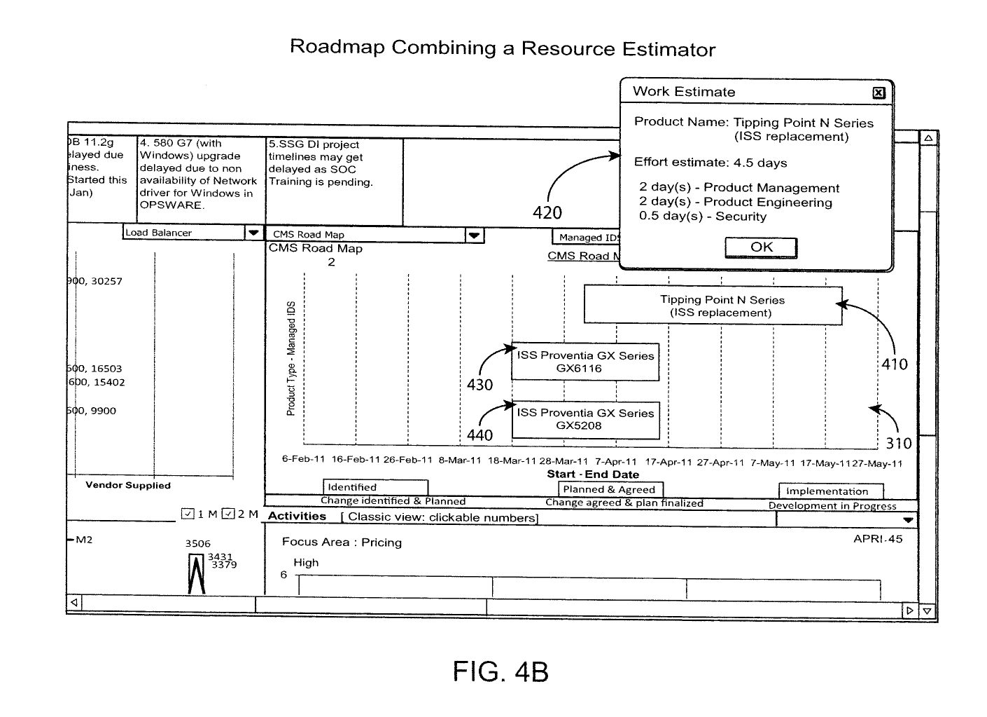

FIG. 3 is an exemplary product management dashboard 300, including roadmap 310. Referring to FIGS. 4A-4B, exemplary embodiments of roadmap 310 are described in greater detail. FIG. 4A is an exemplary roadmap module view in which events may be depicted by graphical elements of varying size, such that a larger size denotes a more serious or more resource-intensive event. In particular, the events in FIG. 4A are depicted by circles, wherein a larger circle depicts the end of support for its associated product and a smaller circle denotes the end of sale of its associated product. Although circles are utilized, any suitable shape may be used.

In addition, a resource estimate is available for each event denoted on roadmap 310. A resource estimate may include a projected amount of labor required from one or more divisions of an organization or company charged with managing various aspects of the event. The resource estimate may be expressed in man days, man hours, overtime hours, or in any other suitable resource unit. Alternatively or additionally, the resource estimate may include projected types and numbers of required equipment, along with such associated resources as gas, electricity, and the like. Accordingly, the resource estimate may be alternatively or additionally expressed in gallons, kilowatt-hours (kWh), or in any other suitable resource unit. The resource estimates may be customized based on characteristics of the managing organization, such as its expertise, personnel, equipment inventory, and so on. For example, in FIG. 4B, event 410 is associated with resource estimate 420. Resource estimate 420 indicates that event 410 is a minor upgrade requiring 4.5 man days of resources comprising 2 days of Project Management, 2 days of Project Engineering, and 0.5 days of Security. In some embodiments, event 410 may additionally be associated with a cost estimate denoting a monetary cost associated with resource estimate 420. Resource estimate 420 may be displayed, for example, by clicking on event 410 via user input device 24. Alternatively or additionally, resource estimate 420 may be displayed by hovering over event 410 or by any suitable means.

In some embodiments, a user of dashboard 300 may reposition one or more events in roadmap 310 with respect to time. Such repositioning may be accomplished graphically via user input device 24. For example, event 410 may be moved forward a month in time to avoid overlapping the resources and costs associated with each of events 410, 430, and 440. This feature allows costs, which may otherwise peak at a given time, to be spread out over time, thereby easing budgetary constraints. This type of flexibility also allows for a better utilization of resources. In some of these embodiments, an event may only be repositioned forward in time, but not prior to its scheduled occurrence on the roadmap 310. In this way, a misleading schedule resulting in an event not occurring at all may be prevented.

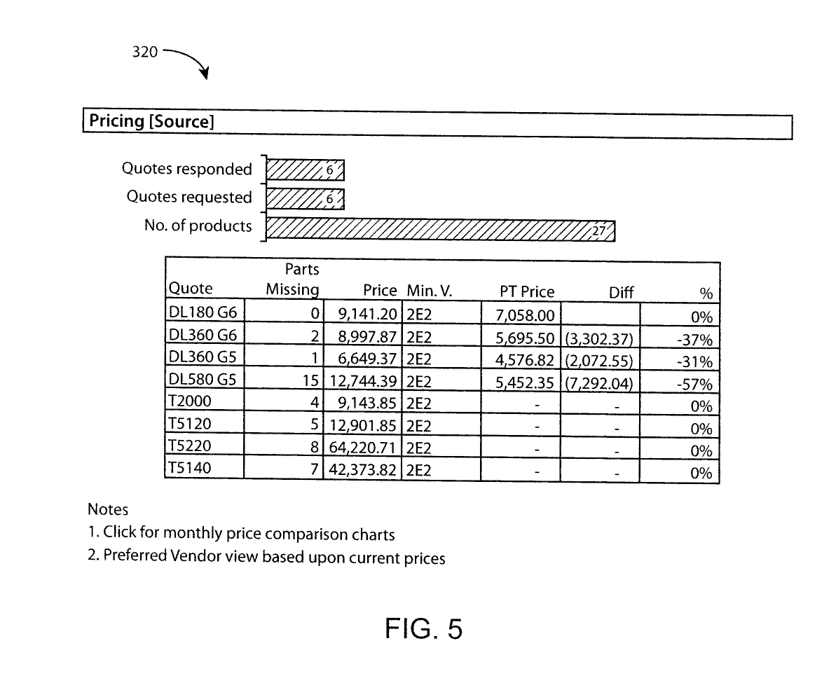

FIG. 5 is an exemplary pricing module 320 which may also be included in dashboard 300. Here, updated pricing information across the portfolio of products may be displayed by the product management computing device 12 based at least in part on pricing data received or stored in memory 20. In some embodiments, the pricing information may be updated regularly. In some of these embodiments, a user may configure (e.g., via user input device 24) the period at which such updates occur. This feature allows for a single point-of-contact for cost inquiries, thereby reducing time otherwise spent chasing down accurate quotes. Moreover, savings or costs from discounts or product price changes can be passed on to the customer in real time, thereby increasing profit margins, reducing financial exposure, and/or increasing competitiveness.

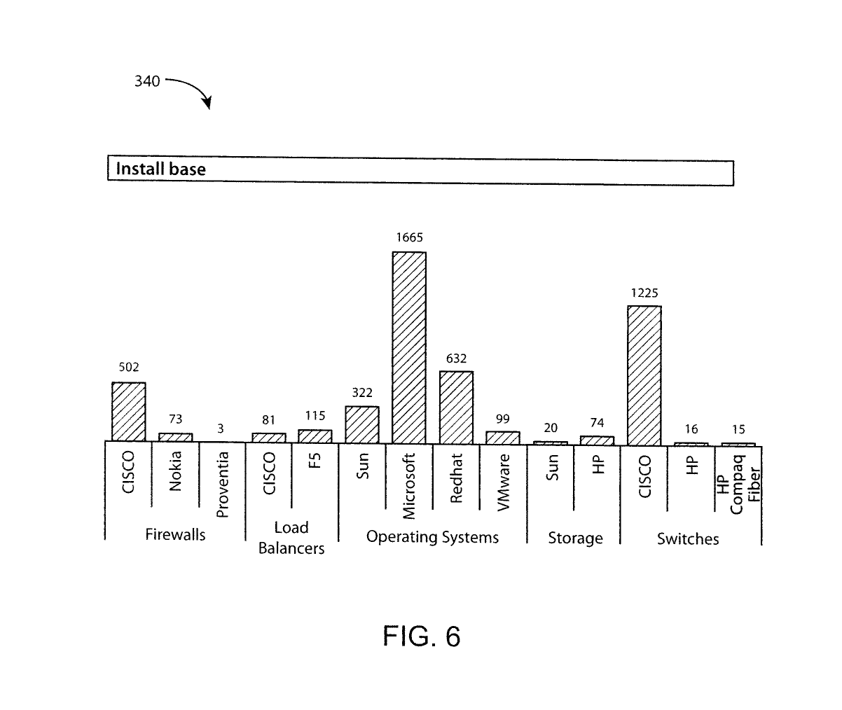

FIG. 6 is an exemplary installed base module 340 which may also be included in dashboard 300. Product management computing device 12 displays the installed base of the portfolio of products (e.g., the number of units of each product actually in use) based at least in part on sales and/or useful life data received or stored in memory 12. In some embodiments, the installed base module 340 displays trending information, thereby reflecting changes in customer demand and influencing scheduling of events in roadmap 310. In some embodiments, the installed base module 340 may be updated regularly. In some of these embodiments, a user may configure (e.g., via user input device 24) the period at which such updates occur. Beneficially, the installed base may be factored into product launch or EOL decisions. Moreover, vendor discounting and licensing may be centrally controlled and regulatory compliance may be improved.

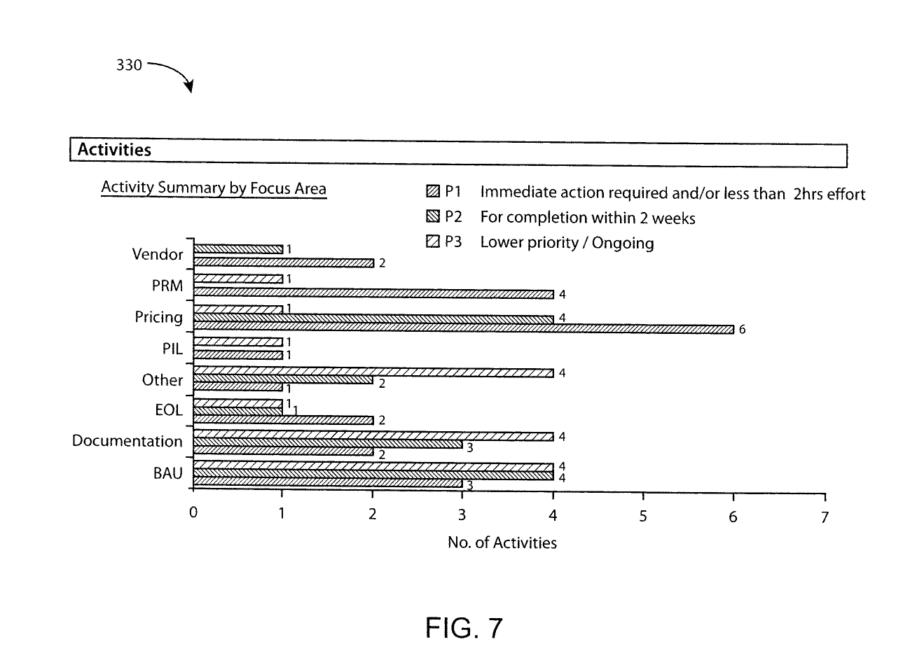

FIG. 7 is an exemplary activities tracker module 330 which may also be included in dashboard 300. Here, product management computing device 12 may display a quantity of pending projects and an estimated time to completion for each based at least in part on event data received or stored in event database 21. In some embodiments, the pending projects may be categorized by a focus area. In some embodiments, the activities tracker module 330 may be updated regularly. In some of these embodiments, a user may configure (e.g., via user input device 24) the period at which such updates occur. Beneficially, activities tracker module 330 may highlight where the greatest amount of resources are being spent. Priority issues may be readily addressed. Moreover, activities tracker module 330 provides visibility as to the full range of product management activities in a single view.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing a product, the method comprising:
receiving, by a product management computing device, event data related to one or more events associated with a lifecycle of a portfolio of one or more products;
comparing, by the product management computing device, the received event data with a resource model;
determining, by the product management computing device, based at least in part on the comparing, an estimated number of resources required to implement each of the one or more events; and
displaying, by the product management computing device, based at least in part on the received data, a dashboard comprising one or more analytic modules, at least one of the analytic modules comprising a roadmap across the portfolio of one or more products, the roadmap comprising a timeline of the one or more events and the determined estimated number of resources required to implement each of the one or more events.

2. The method of claim 1, wherein the comparing further comprises compiling at least a portion of the event data into an event template associated with the resource model.

3. The method of claim 1, wherein the resource model is associated with a cost model.

4. The method of claim 3, the method further comprising determining, based at least in part on the cost model, an estimated cost required to implement each of the one or more events.

5. The method of claim 4, wherein the roadmap comprises an option to reposition each of the one or more events after its actual occurrence on the timeline, thereby enabling the estimated cost associated with each repositioned event to be correspondingly repositioned forward in time.

6. The method of claim 1, wherein the one or more events comprises at least one of release events, end of sale events, or end of support events.

7. The method of claim 1, wherein at least one of the one or more analytic modules comprises updated pricing information across the portfolio of one or more products.

8. The method of claim 1, wherein at least one of the one or more analytic modules comprises an activities tracker displaying a quantity of pending projects and an estimated time to completion for each of the pending projects.

9. The method of claim 8, wherein the pending projects are categorized by a focus area.

10. The method of claim 1, wherein at least one of the one or more analytic modules comprises an installed base of the portfolio of one or more products.

11. The method of claim 10, wherein at least one of the one or more analytic modules displays trends in the installed base of the portfolio of one or more products.

12. A computer-readable storage medium having stored thereon instructions for managing a product, the instructions comprising machine executable code which, when executed by at least one processor, causes the processor to perform steps comprising:
receiving event data related to one or more events associated with a lifecycle of a portfolio of one or more products;
comparing the received event data with a resource model;
determining, based at least in part on the comparing, an estimated number of resources required to implement the one or more events; and
displaying, based at least in part on the received data, a dashboard comprising one or more analytic modules, at least one of the analytic modules comprising a roadmap across the portfolio of one or more products, the roadmap comprising a timeline of the one or more events and the determined estimated number of resources required to implement each of the one or more events.

13. The medium as set forth in claim 12, wherein the comparing further comprises compiling at least a portion of the event data into an event template associated with the resource model.

14. The medium as set forth in claim 12, wherein the resource model is associated with a cost model.

15. The medium as set forth in claim 14 further comprising:
determining, based at least in part on the cost model, an estimated cost required to implement each of the one or more events.

16. The medium as set forth in claim 15, wherein the roadmap comprises an option to reposition each of the one or more events after its actual occurrence on the timeline, thereby enabling the estimated cost associated with each repositioned event to be correspondingly repositioned forward in time.

17. The medium as set forth in claim 12, wherein the one or more events comprises at least one of release events, end of sale events, or end of support events.

18. The medium as set forth in claim 12, wherein at least one of the one or more analytic modules comprises updated pricing information across the portfolio of one or more products.

19. The medium as set forth in claim 12, wherein at least one of the one or more analytic modules comprises an activities tracker displaying a quantity of pending projects and an estimated time to completion for each of the pending projects.

20. The medium as set forth claim 19, wherein the pending projects are categorized by a focus area.

21. The medium as set forth in claim 12, wherein at least one of the one or more analytic modules comprises an installed base of the portfolio of one or more products.

22. The medium as set forth in claim 21, wherein at least one of the one or more analytic modules displays trends in the installed base of the portfolio of one or more products.

23. A product management computing device for managing a product, the device comprising:
one or more processors;
a memory coupled to the one or more processors which are configured to execute programmed instructions stored in the memory, the programmed instructions comprising:
receiving event data related to one or more events associated with a lifecycle of a portfolio of one or more products;
comparing the received event data with a resource model;
determining, based at least in part on the comparing, an estimated number of resources required to implement the one or more events; and
displaying, based at least in part on the received data, a dashboard comprising one or more analytic modules, at least one of the analytic modules comprising a roadmap across the portfolio of one or more products, the roadmap comprising a timeline of the one or more events and the determined estimated number of resources required to implement each of the one or more events.

24. The device as set forth in claim 23, wherein the comparing further comprises compiling at least a portion of the event data into an event template associated with the resource model.

25. The device as set forth in claim 23, wherein the resource model is associated with a cost model.

26. The device as set forth in claim 25 further comprising:
determining, based at least in part on the cost model, an estimated cost required to implement each of the one or more events.

27. The device as set forth in claim 26, wherein the roadmap comprises an option to reposition each of the one or more events after its actual occurrence on the timeline, thereby enabling the estimated cost associated with each repositioned event to be correspondingly repositioned forward in time.

28. The device as set forth in claim 23, wherein the one or more events comprises at least one of release events, end of sale events, or end of support events.

29. The device as set forth in claim 23, wherein at least one of the one or more analytic modules comprises updated pricing information across the portfolio of one or more products.

30. The device as set forth in claim 23, wherein at least one of the one or more analytic modules comprises an activities tracker displaying a quantity of pending projects and an estimated time to completion for each of the pending projects.

31. The device as set forth claim 30, wherein the pending projects are categorized by a focus area.

32. The device as set forth in claim 23, wherein at least one of the one or more analytic modules comprises an installed base of the portfolio of one or more products.

33. The device as set forth in claim 32, wherein at least one of the one or more analytic modules displays trends in the installed base of the portfolio of one or more products.
